(19) United States
(12) Patent Application Publication
(10) Pub. No.: US 2026/0175968 A1
(43) Pub. Date: Jun. 25, 2026

(54) System for mimicking the behavior of a multi-engine aircraft with a single engine aircraft

(71) Applicant: DAHER AEROSPACE, ORLY (FR)

(72) Inventors: Christophe ROBIN, ORLY (FR); Guillaume LABEDAN, ORLY (FR)

(73) Assignee: DAHER AEROSPACE, ORLY (FR)

(21) Appl. No.: 19/423,687

(22) Filed: Dec. 17, 2025

(30) Foreign Application Priority Data
Dec. 20, 2024 (FR) 2414983

(51) Int. Cl. B64C 13/50; B64C 9/00; B64C 13/18; B64D 27/02; B64D 27/14; B64D 27/31; B64D 31/10; B64D 31/14; B64D 31/16; B64D 43/00; B64F 5/10; B64F 5/60; F16H 48/08

(52) U.S. Cl. CPC B64C 13/503; B64C 9/00; B64C 13/18; B64D 27/026; B64D 27/14; B64D 27/31; B64D 31/10; B64D 31/14; B64D 31/16; B64D 43/00; B64F 5/10; B64F 5/60; B64C 2009/005; F16H 48/08

(57) ABSTRACT

A fly-by-wire system that lets a single-engine aircraft mimic multi-engine behavior for real-flight pilot training, especially asymmetric thrust effects that create yaw/roll. A cockpit central thrust control with two independent thrust levers generates an overall power command plus a dissymmetry signal; a calculator applying a dedicated control law converts these into corrected setpoints for the rudder, left/right ailerons, and propeller parameters to reproduce multi-engine handling. Instructors may trigger a simulated engine failure and then reset back to normal single-engine operation. Optional wingtip electric thrusters powered by a battery may increase asymmetric effects while maintaining safety margin, and the system may display/record simulated multi-engine data for debriefing—reducing training cost and CO₂ versus operating real twins

### CROSS REFERENCE TO RELATED APPLICATIONS

This application claims priority of French application FR2414983 filed on Dec. 20, 2024 the content of which is hereby introduced by reference in its entirety.

### TECHNICAL FIELD

The present disclosure relates generally to fly-by-wire controls and more specifically to system, method and apparatuses for mimicking the behavior of a multi-engine aircraft with a single-engine aircraft.

### BACKGROUND ART

Fly-by-wire enables the aerodynamic surfaces and engines of an aircraft to be piloted according to some actions of the pilot on the control devices such as throttle control, broomstick, rudder pedals and/or other control devices without direct mechanical link, such as cables, between these control devices and the controlled means.

An action of the pilot on a control member is measured, for example by means of a position sensor, this measurement is interpreted by a calculator, which transcribes this action into a set of orders sent to actuators acting on aerodynamic surfaces or engines according to a control law.

This control law aims to optimize the operation of the aircraft and its safety by maintaining it in its flight envelope.

Depending on the aircraft, several control laws may be used and selected, for example depending on the flight phase, so that the same action on one or more control devices may result in different movements from the actuators taken individually or in combination.

Thus, the selection of a control law makes it possible to completely alter the behavior of an aircraft in response to a control setpoint entered by the pilot via the control devices.

Even if fundamentally changing the behavior of the aircraft is not the aim of fly-by-wire, there are examples that may lean toward such objective.

For example, document WO 2021/224490A1 describes a multi-propeller aircraft comprising a plurality of electric motors on each wing, whose control devices are those of a single-engine aircraft, featuring a single thrust controller, and whose calculators associated with the fly-by-wire controls reproduce the behavior of a single-engine aircraft.

Document WO 2008/097319A2 discloses an aircraft with fly-by-wire controls whose calculator may generate a plurality of simulated control signals from at least one aircraft control device without direct pilot intervention.

The training and the qualification of pilots on a multi-engine aircraft are expensive because such an aircraft exhibits high operating and maintenance costs.

Such training includes learning to react and to follow protocols in the event of a damage resulting in a dissymmetrical behavior, particularly in case of an engine failure.

Such a damage mainly translates in yaw and roll responses of the aircraft the combination of which may lead to a behavior that may destabilize the pilot up to the loss of control of the aircraft.

As of today, for exposing an apprentice pilot to such a type of unusual behavior, the solution is either a simulator or the use of a twin-engine aircraft voluntarily set under such dissymmetrical condition, the latter having a cost as well as a high carbon footprint, since the operation of a twin-engine aircraft is of financial and carbon emission costs which are 2 to 3 times higher than those of a single-engine aircraft.

In addition, generating a dissymmetrical situation, for instance by voluntarily stopping one of the engines of a twin-engine aircraft presents risks, even in the presence of a flight instructor, the aircraft may become unstable and unrecoverable in the case of an inappropriate maneuver by the student pilot.

### SUMMARY

The described techniques relate to methods, system, device and apparatus that support techniques for mimicking the behavior of a multi-engine aircraft with a single engine aircraft. Some implementations may provide a system for mimicking the behavior of a multi-engine aircraft with a single-engine aircraft including an aircraft comprising an on-board cockpit comprising at least one control device, a main thruster and a fly-by-wire control center configured to move at least one aerodynamic surface among a rudder, a right-wing aileron and a left-wing aileron in response to an action on the at least one control device. The fly-by-wire control center may be further configured to modify at least one operating parameter of the main thruster in response to an action on the at least one control device, the control device may comprise a central thrust control comprising two independent thrust levers, configured to issue a power control signal and a dissymmetry signal based on an average angular position and a difference in angular position between the two independent thrust levers. The fly-by-wire control center may comprise at least one calculator comprising an input port configured to receive a power control signal and a dissymmetry signal, a non-volatile memory comprising a control law and instructions configured to make the at least one calculator processing the power control signal and the dissymmetry signal an to issue at least one of a corrected left wing aileron position setpoint signal, a corrected right wing aileron position setpoint signal, a corrected rudder position setpoint signal, a corrected propeller speed setpoint signal and a corrected propeller pitch setpoint signal. The control law and the at least one calculator may be configured to mimic the behavior of an aircraft comprising more than one main thruster.

Thus, the use of a specific control law for the piloting of the main thruster and aerodynamic surfaces according to the pilot's actions on the control devices, makes it possible to make the single-engine aircraft behave similar to a multi-engine aircraft, and in particular to mimic a dissymmetry in propulsion.

The main thruster may be a turboprop for reliability. In some implementations the system may comprise an auxiliary electric thruster on each wing and the calculator and control law are configured to process at least one operating parameter relating to each auxiliary electric thruster.

The control device may comprise an engine failure simulation command configured to trigger a mimicked aircraft behavior subject to an engine failure and may further comprise a reset command configured to exit the mimicked behavior.

The fly-by-wire control center may comprise a secondary fly-by-wire device including a database comprising the control law of the mimicked aircraft, a processor, a memory comprising instructions to make the processor to process signals arriving on the input port. The processing may be implemented by a dissymmetry processing component, a power control component, a display component, a recording component, and a resetting component.

In some implementation, the two independent thrust levers of the central thrust control may act on a power control shaft of the main thruster via a differential gear train comprising a left sun-gear connected to a left-hand thrust lever, a right sun-gear connected to a right hand thrust lever, a planetary gear geared with the left sun-gear and the right sun-gear and held by a planet carrier, the power control shaft being connected in rotation with the planet carrier. The planetary gear may be connected in rotation with a dissymmetry shaft, an angular position of the dissymmetry shaft being set by the difference in angular positions of the two independent thrust levers and measured by a dissymmetry shaft angular sensor issuing the dissymmetry signal. The central thrust control may comprise a left sun-gear angular position sensor and a right sun-gear angular position sensor. The display component may be configured to generate a signal towards an engine gauges display showing the thrust power of a left engine and a thrust power of a right engine according to angular positions delivered by the left sun-gear angular position sensor and the right sun-gear angular position sensor. The recording component may be configured to record timestamped positions of left-hand thrust lever and of the right-hand thrust lever from angular positions delivered by the left sun-gear angular position sensor and the right sun-gear angular position sensor.

The system may be implemented in a method for adapting a single-engine aircraft for operating like a multi-engine aircraft, which may comprise steps of installing on the single-engine aircraft at least one supplementary fly-by-wire controlled aerodynamic surface. The method may further comprise a step of installing a secondary fly-by-wire control device comprising a control law and configured to control the at least one fly-by-wire controlled supplementary aerodynamic surface. In some implementation the method may further comprise a step of installing a central thrust control comprising two independent thrust levers configured to issue a power control signal and a dissymmetry signal based on an average angular position and a difference in angular position between the two independent thrust levers. The secondary fly-by-wire control device may be configured to issue at least one of a corrected propeller speed setpoint signal, a corrected propeller pitch setpoint signal, a corrected aileron position setpoint signal and a corrected rudder position signal from the power control signal and the dissymmetry signal. In some implementation the method may comprise a step of installing auxiliary electric thrusters at wing tips of the single-engine aircraft wherein the operating conditions of the auxiliary electric thrusters are controlled by the secondary fly-by-wire control device based on the power control signal and the dissymmetry signal.

### BRIEF DESCRIPTION OF THE DRAWINGS

FIG. 1 represents an example of an aircraft which supports techniques for implementing a system for mimicking the behavior of a multi-engine aircraft with a single-engine aircraft in accordance with various aspects of the present disclosure.

FIG. 2 is a schematic view in perspective of an example of a cockpit of a single-engine aircraft which supports techniques for implementing a system for mimicking the behavior of a multi-engine aircraft with a single-engine aircraft in accordance with various aspects of the present disclosure.

FIG. 3 is an example of a kinematic diagram of a central thrust control which supports techniques for implementing a system for mimicking the behavior of a multi-engine aircraft with a single-engine aircraft in accordance with various aspects of the present disclosure.

FIG. 4 is a simplified functional diagram of a primary and secondary electrical control device of a single-engine aircraft which supports techniques for implementing a system for mimicking the behavior of a multi-engine aircraft with a single-engine aircraft in accordance with various aspects of the present disclosure.

FIG. 5 is a flow chart of a method for upgrading a single-engine aircraft to an aircraft which supports techniques for implementing a system for mimicking the behavior of a multi-engine aircraft according to various aspects of the disclosure.

FIG. 6 is a diagrammatic representation of an apparatus which supports techniques for implementing a system for mimicking the behavior of a multi-engine aircraft with a single-engine aircraft in accordance with various aspects of the present disclosure.

### DETAILED DESCRIPTION

A system, device, method and apparatus are described for enabling a single-engine aircraft to mimic the behavior of a multi-engine aircraft for the purpose of training pilot students to operate a multi-engine aircraft in real flight conditions.

Compared to a real multi-engine aircraft, the system of the disclosure may provide at least one of the following advantages:
reducing the pilot training costs by using an aircraft of a simpler configuration, like a single-engine instead of multi-engine;
reducing the CO₂ impact of training flights by at least 50% at equivalent flight time;
improving the aerodynamic efficiency of the aircraft compared to a multi-engine for non-dissymmetric flights;
improving safety and reducing the risk of loss of control, particularly in simulated engine failure situations;
enabling ground flight analysis insofar as all orders go through a calculator for all simulated functions and all control and dissymmetry data can be recorded;
simulating on the same basis other motorization cases, the same single-engine aircraft may be used for single-engine, twin-engine and four-engine aircrafts training.

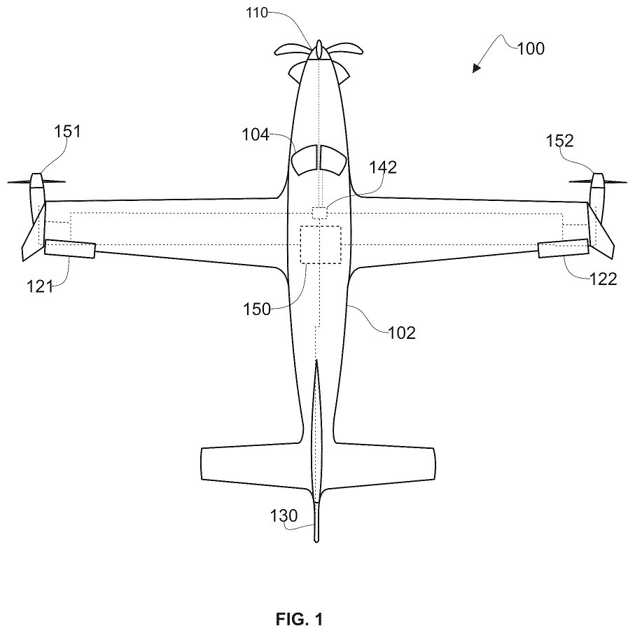

FIG. 1 shows a system diagram 100 which supports techniques for mimicking the behavior of a multi-engine aircraft with a single-engine aircraft in accordance with various aspects of the present disclosure. As depicted in FIG. 1 the system diagram 100 may include an aircraft 102, comprising a cockpit 104, a main thruster 110, a rudder 130, a left-wing aileron 121 a right-wing aileron 122, a fly-by-wire control center 142, a battery 150, a left side auxiliary electric thruster 151, a right side auxiliary electric thruster 152 and/or other components.

The aircraft 102 may be a single-engine fixed-wing aircraft which, in nominal operation, is propelled by a single main thruster 110 which may be a turboprop.

The aircraft may be an existing single-engine aircraft with primary electrical controls or not, which may receive specific arrangements which enables to generate a dissymmetric behavior.

For example, these arrangements may include aerodynamic surfaces such as ailerons 121, 122 on each of the wings which may generate a roll effect and a rudder 130 which may generate a yaw effect.

The fly-by-wire control center 142 may receive information from the control devices of the cockpit 104 and translate such information in setpoints for the operation of the main thruster 110, the left-wing aileron 121, the right-wing aileron 122, the rudder 130 and/or other components.

The fly-by-wire control center 142 may be already present in the aircraft or may be added specifically to provide the functions required by the techniques for mimicking the behavior of a multi-engine aircraft with a single-engine aircraft, if the original single-engine aircraft is not fly-by-wire.

For instance, the ailerons and the rudder may be those of the existing aircraft, they may also be aerodynamic extensions attached to existing surfaces to increase their effects, or, in particular when the aircraft is not fly-by-wire controlled, they may be added aerodynamic surfaces which are electrically controlled by the fly-by-wire control center 142.

Alternatively, or additionally to the aerodynamic extensions, the aircraft may comprise a battery 150 and auxiliary electric thrusters 151, 152 that may be installed, for example, at the wings tips and supplied in energy by the battery.

The battery 150 may be of the Li-ion-Nickel-Manganese-Cobalt type, the Li-ion-Nickel-Cobalt-Aluminum type, the Li-ion-Lithium-Iron-Phosphate type, the solid state type, or any other battery technology adapter to supply the requested power to the auxiliary electric thrusters 151, 152 under a voltage comprised in 400V to 1000V.

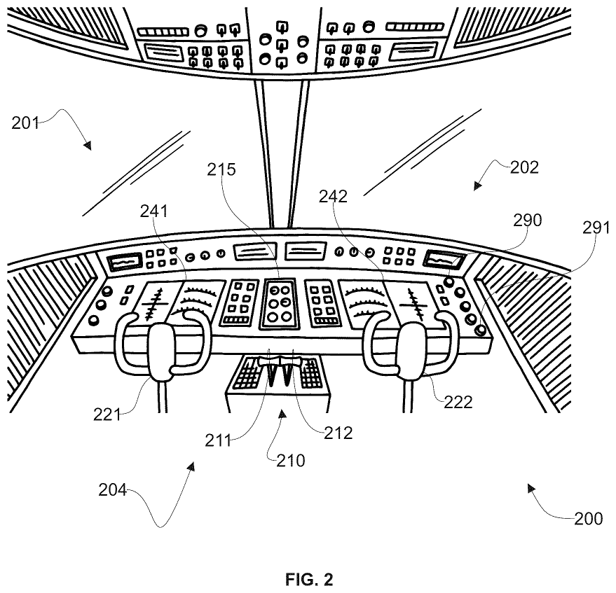

FIG. 2 shows a cockpit diagram 200 of an aircraft comprising a system which supports techniques for mimicking the behavior of a multi-engine aircraft with a single-engine aircraft in accordance with various aspects of the present disclosure. As depicted in FIG. 2 the cockpit diagram may comprise an onboard cockpit 204, a pilot seat 201, a flight instructor seat 202, a pilot computer screen 241, a flight instructor computer screen 242, and engine gauges display 215, a pilot broomstick 221, a flight instructor broomstick 222, a central thrust control 210 comprising a left-hand thrust lever 211 and a right-hand thrust ever 212, an engine failure simulation command 290, a reset command 291, and/or other components notably rudder pedals (not shown) on the pilot side and on the flight instructor side.

The control devices: broomsticks 221, 222, central thrust control 210, rudder pedals and other control devices may comprise one or more position sensors, for example one or more incremental encoders. The position information of a control device is interpreted by a calculator of the fly-by-wire control center 142 and translated in movement orders to the aerodynamic surfaces, either existing aerodynamic surfaces or fly-by-wire additional aerodynamic surfaces according to a command law in a fly-by-wire control device.

The parameters of the main engine may be set according to a function of the relative position of the two independent thrust levers 211, 212, according to an average angular position and a difference in angular position of the thrust levers.

The control of the main thruster 110 through the central thrust control 210 may be purely electric for example according to information delivered by one or more encoders measuring the position of each independent thrust lever, then performing a mathematical processing of this information, or, according to another example, the main thruster control may, at least in part, be based on a mechanical device using, for example, a differential gear train as described below, which acts on an existing control in place of the single-lever control of the main thruster, or, by a combination of these embodiments.

Thus, by maneuvering the central thrust control 210 with two independent thrust levers, the pilot student reproduces thrust and drag effects similar to those of a twin-engine.

The onboard cockpit 204 may be of a single-engine aircraft, that is to say the pilot and the flight instructor actually fly in the aircraft mimicking the behavior of a multi-engine aircraft, the controlled aerodynamic surfaces are subject to an aerodynamic flow and produce lifts and drags, the electrical controls modify the actual flight conditions: It is not a ground flight simulator.

The engine failure simulation command 290 may be activated by the flight instructor and may trigger a corresponding behavior of the aircraft. When activating the engine failure simulation command 290 the power of the main thruster is reduced by half and the controls of the aerodynamic surfaces are adjusted to reproduce the effect of such a failure on the yaw and roll of the aircraft.

The reset command 291 may allow the flight instructor to exit the simulated behavior mode and to return to a symmetrical, single-engine behavior.

The flight instructor may select different modes for the engine gauges display 215: either a single-engine display, with a gauge per parameter corresponding to the actual operating parameters of the main thruster, or a simulated twin-engine display with gauges for each engine parameters based, in particular, on a power control signal issued from the central thrust control 210.

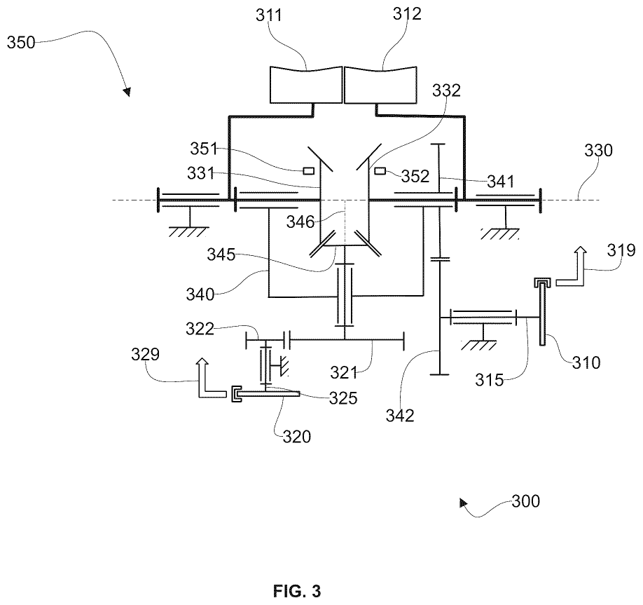

FIG. 3 shows embodiment diagram 300 of a central thrust control adapted to a system which supports techniques for mimicking the behavior of a multi-engine aircraft with a single-engine aircraft in accordance with various aspects of the present disclosure. As depicted in FIG. 3 such an embodiment diagram 300 comprises a central thrust control 350 comprising a left-hand thrust lever 311 and a right-hand thrust lever 312, a power control shaft 315, a power control shaft gear train 341, 342, a control shaft angle sensor 310, a thruster power signal 319, a sun-gear axis 330, a left sun-gear 331, a right sun-gear 332, a planetary gear 345, a planetary spinning axis 346, a planet carrier 340, a dissymmetry control shaft 325, a dissymmetry control shaft gear train 321, 322, a dissymmetry shaft angular sensor 320, a dissymmetry signal 329, an left sun-gear angular position sensor 351, a right sun-gear angular position sensor 352 and/or other components.

The central thrust control 350 as well as the left-hand thrust lever 311 and the right-hand thrust lever 312 may be the same as or similar to the central thrust control 210, the left-hand thrust lever 211 and the right-hand thrust lever 212 as depicted in FIG. 2.

The left sun-gear 331 is connected to the left-hand thrust lever 311 and rotates around the sun-gear axis 330 when the right-hand thrust lever is maneuvered, symmetrically, the right sun-gear 332 is connected to the right-hand thrust lever 312 and rotates about the sun-gear axis when the left-hand thrust lever is maneuvered. Both sun-gears are geared with the planetary gear 345 which may spin about the planetary spinning axis 346 and which is held by the planet carrier 340 which may rotate about the sun-gear axis 330, a set comprising the two sun-gears 331, 332 the planetary gear 345 and the planet carrier 340 making a differential gear train.

The two thrust levers 311, 312 may be moved angularly and independently of each other around the sun-gear axis 330 thus reproducing the configuration of a twin-engine aircraft central thrust control, where each thrust lever controls the power of one of the aircraft engines.

If the two thrust levers 311, 312 are moved angularly together by a same angle around the sun-gear axis 330, the two sun-gears 331, 332 rotates together, the planetary gear 345 does not spin, and the planet carrier 340 rotates around the sun-gear axis by the same angle. The rotational displacement of the planet carrier 340 is transmitted to the power control shaft 315 via the control shaft gear train 341, 342 causing the power control shaft to rotate by an angle proportional to the same angle according to the control shaft gear train gear ratio. The angular displacement of the power control shaft may be measured by the control shaft angle sensor 310 which issues a power control signal 319, which may be analog or digital for controlling the power of the main thruster of the aircraft. The control shaft angle sensor 310 may be an incremental encoder that delivers a power control signal 319 proportional to the angular position of the power control shaft 315.

The power control signal 319 may be interpreted by a calculator of the fly-by-wire control device of the main thruster, commonly referred to as “FADEC” for “Full Authority Digital Engine Control” and translated to thrust conditions to be applied to the main thruster. The FADEC may control multiple parameters of the main thruster such as an engine regime, a propeller pitch etc. and/or other parameters.

When the two independent thrust levers 311, 312 are moved together about the sun-gear axis 330 by an a angle, then the angular displacement of the first gear 341 of the control shaft gear train is also a. The rotation angle of the power control shaft 315 is proportional to a depending on the gear ratio of the control shaft gear train.

Since the planetary gear 345 does not spin in such a configuration, the dissymmetry control shaft 325 does not spin either, therefore, when the two thrust levers are moved together by a same angle, the aerodynamic surfaces position is not changed in response to these thrust levers maneuver.

In another configuration, if one of the thrust levers, for instance the left-hand thrust lever 311 is moved angularly by an angle around the sun-gear axis 330 while the other thrust lever, the right-hand thrust lever 312 in this example, remains still, the left sun-gear 331 rotates by the angle while the right sun-gear does not move. In a twin-engine aircraft, such a configuration may result in a dissymmetry in the thrust power delivered by the engines.

The rotation of the left sun-gear 331 will cause both the planetary gear 345 to spin about the planetary spinning axis 346 by a spinning angle proportional to the angle according to a gear ratio between the left sun-gear 331 and the planetary gear 345, and the planet carrier to rotate around the sun-gear axis 330 by planet carrier angle proportional to a gear ratio between the planetary gear 345 and the right sun-gear 332.

If, for example, the respective number of teeth Zᵢ are such that:
Z₃₃₂=Z₃₃₁=2·Z₃₄₅
Z₃₄₁=Z₃₄₂

Then, in this example, the gear ratio between the left sun-gear 331 and the planetary gear 345 is 2 and the gear ratio between the planetary gear 345 and the right sun-gear 332 is ½. Then, for an angular displacement δ of one of the two thrust levers relative to the other, the angular displacement of the first gear 341 of the control shaft gear train driven by the planet carrier 340 is δ/2, the angular displacement of the power control shaft 315 is proportional to δ/2 depending on the gear ratio of the control shaft gear train.

The power control signal 319 is proportional to an angular average position and a difference in angular positions of the two independent thrust levers. The power requested from the main thruster via this mechanism corresponds to the sum of the powers that would be requested from two thrusters, given the position of two levers on a twin-engine.

The spinning angle of the planetary gear 345 about the planetary spinning axis 346 and will rotate the dissymmetry control shaft 325 by a dissymmetry angle proportional to the angle, the proportionality being given by the gear ratio of the dissymmetry control shaft gear train 321, 322. The rotation angle of the dissymmetry control shaft 325 may be measured by the dissymmetry shaft angular sensor 320, which issues a dissymmetry signal 329 that may further be interpreted to generate an order for moving the aerodynamic surfaces of the aircraft and to reproduce the aerodynamic effects of the thrust dissymmetry.

For instance, if the right-hand thrust lever 312 is pushed forward and the left-hand thrust lever 311 is pulled completely backward, then the position of the control shaft angle sensor 310 of the power control shaft 315 is half-course of the power control signal 319 leads the FADEC to operate the main thruster at half-power. The position of the dissymmetry control shaft 325 is such that the dissymmetry signal 329 leads the fly-by-wire control of the rudder and ailerons such that the aircraft experience a yaw to the left and a roll by an elevation of the right wing.

The combination of the power control of the main thruster and of the aerodynamic surfaces by the differential gear train makes it possible to mimic the behavior of a twin-engine aircraft, although the aircraft is actually a single-engine aircraft.

The left sun-gear angular position sensor 351 and the right sun-gear angular position sensor 352, deliver information about the angular position of each thrust lever, such information may be used to display engines operation in the engine gauges display 215 and to record flight parameters as if the aircraft was a multi-engine aircraft.

The central thrust control may comprise a locking device for locking together the two independent thrust levers, which, when engaged, prevents any relative movement of one thrust lever relative to the other. In such conditions, the thrust control acts on the power control shaft 315 of the main thruster as the single lever of a single-engine aircraft.

The calculator may comprise safety features so that the triggering of such a virtual failure, but with actual effects, or inappropriate action of the student pilot facing this situation are recorded, for example for the purpose of reporting a training session, but do not lead to too an unstable behavior of the aircraft.

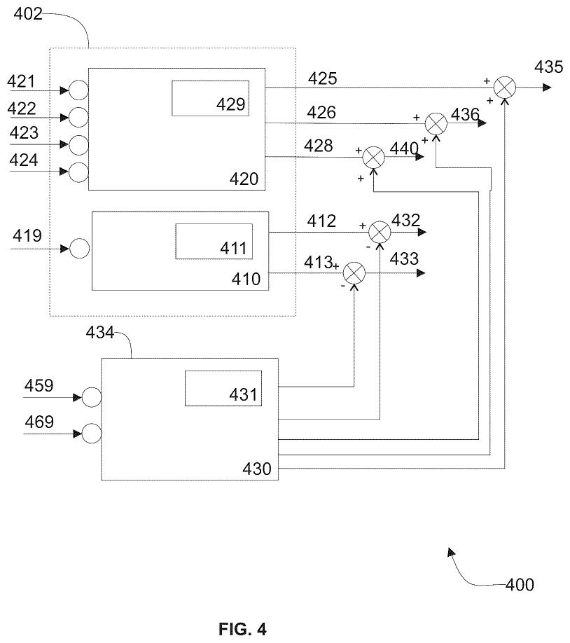

FIG. 4 shows a fly-by-wire control center diagram 400 adapted to a system which supports techniques for mimicking the behavior of a multi-engine aircraft with a single-engine aircraft in accordance with various aspects of the present disclosure. As depicted in FIG. 4 the fly-by-wire control center diagram 400 may comprise a primary fly-by-wire control device 402, a first calculator 410 a first non-volatile memory 411, a propeller speed setpoint signal 412, a propeller pitch setpoint signal 413, a main thruster control signal 419, a second calculator 420, a second non-volatile memory 429 a pilot broomstick signal 421, a flight instructor broomstick signal 422, a pilot rudder pedals position signal 423, a flight instructor rudder-pedals position signal 424, a left-wing aileron position setpoint signal 425, a right wing aileron position setpoint signal 426, a rudder position setpoint signal 428, a secondary fly-by-wire control device 434, a third calculator 430, a third non-volatile memory 431, a corrected left wing aileron position setpoint signal 435, a corrected right wing aileron position setpoint signal 436, a corrected rudder position setpoint signal 440, a corrected propeller speed setpoint signal 432, a corrected propeller pitch setpoint signal 433, a power control signal 459, a dissymmetry signal 469 and/or other components. The flight-by-wire control center may be the same as or similar to the fly-by-wire control center 142 depicted in FIG. 1. The power control signal 459 and the dissymmetry signal 469 may be the same as or similar to the power control signal 319 and the dissymmetry signal 329 as depicted in FIG. 3.

The primary fly-by-wire control device 402 may comprise a first calculator 410 processing the engine parameters of the main thruster, comprising a non-volatile memory 411 comprising a control law and instructions to make the first calculator generating, for example, a propeller speed setpoint, and a propeller pitch setpoint based on at least one signal from a main thruster power control signal 419 issued by a sensor.

The primary flight-by-wire control device 402 may comprise a second calculator 420 comprising a second non-volatile memory 429 comprising a control law and instructions to make the second calculator processing the control of aerodynamic surfaces according to at least one of a pilot broomstick signal 421, a flight instructor broomstick signal 422, a pilot rudder pedals position signal 423, a flight instructor rudder-pedals position signal 424 issued by sensors measuring the positions of these control devices.

The primary fly-by-wire control device may issue, based on the aforementioned input signals, at least one of a left-wing aileron position setpoint signal 425, a right-wing aileron position setpoint signal 426, a rudder position setpoint signal 428, a propeller speed setpoint signal 412, a propeller pitch setpoint signal 413.

The primary fight-by-wire control device 402 may be a fly-by-wire control center already present in the aircraft.

However, as previously stated, it is not necessary for primary controls, in conventional single-engine mode, to be fly-by-wire, these can be of any kind: for example, by cables or hydraulics, provided the aerodynamic surfaces configured to generate dissymmetry are fly-by-wire.

The secondary fly-by-wire control device 434 may be an addon to provide the functions adapted to techniques for mimicking the behavior of a multi-engine aircraft with a single-engine aircraft. The secondary fly-by-wire control device 434 may comprise an input port for receiving a power control signal 459 and a dissymmetry signal 469, a third calculator 430, a third non-volatile memory 431 comprising a control law and instructions to make the third calculator calculating corrections to at least one of a left wing aileron position setpoint signal 425, a right wing aileron position setpoint signal 426, a rudder position setpoint signal 428, a propeller speed setpoint signal 412, a propeller pitch setpoint signal 413, calculated/issued by the primary fly-by-wire control device 402, and/or other components.

The corrections are based on input signals comprising the power control signal 459 and the dissymmetry signal 469. These signals may be generated by the central thrust control, the engine failure simulation command 290 or the reset command 291.

As a result, at least one the left wing aileron position setpoint signal 425, the right wing aileron position setpoint signal 426, the rudder position setpoint signal 428, the propeller speed setpoint signal 412, the propeller pitch setpoint signal 413 are modified before being sent to the main thruster, ailerons and rudder in at least one of a corrected left wing aileron position setpoint signal 435, a corrected right wing aileron position setpoint signal 436, a corrected rudder position setpoint signal 440, a corrected propeller speed setpoint signal 432, a corrected propeller pitch setpoint signal 433, to produce or reset a dissymmetric behavior of a multi-engine aircraft, in terms of yaw, roll and propelling power.

The person skilled in the art understands that the implementation described by considering multiple calculators may be achieved with a single calculator comprising, in a memory, instructions to make the single calculator performing the same functions.

Returning to FIG. 1, the system which supports techniques for mimicking the behavior of a multi-engine aircraft with a single-engine aircraft may comprise a left side auxiliary electric thruster 151, a right side auxiliary electric thruster 152, attached to the wing tips, and supplied in energy by an onboard battery 150 and/or an auxiliary power unit, commonly referred to by APU.

Their spinning speeds and the pitch of the driven propellers may be precisely controlled by the primary fly-by-wire calculator control device according to operating instructions which may also be modified/corrected by the secondary fly-by-wire control device for providing dissymmetry effect.

Located at the ends of the wings, the thrust or drag of these auxiliary engines benefits from a high lever arm to create yaw and roll effects as part of the generation of dissymmetry, which allows, for equal effect, to reduce the power of these engines compared to a real twin-engine aircraft.

Thus, to mimic the dissymmetric behavior of a twin-engine aircraft of 2 times 500 hp (2 times 368 KW), it is possible to use a single-engine aircraft with a main thruster of 120 hp (88.3 KW) and two auxiliary engines, one on each wing end, having a cumulative power of around 100 hp (73.6 kW).

Typically, auxiliary electric motors are powered by a voltage comprised between 400 volts and 1000 volts

The power of auxiliary electric thrusters may be significantly lower than that of the main thruster, but they may introduce greater dissymmetry effects or simulated power variations without lowering the power of the main thruster and thus maintaining a certain safety margin.

Although the above examples are limited to the case of a twin-engine mimicked aircraft by a system comprising a single-engine aircraft, the person skilled in the art understands that these principles may be applied regardless of the number of engines of the mimicked aircraft, for example, three-engine or four-engine.

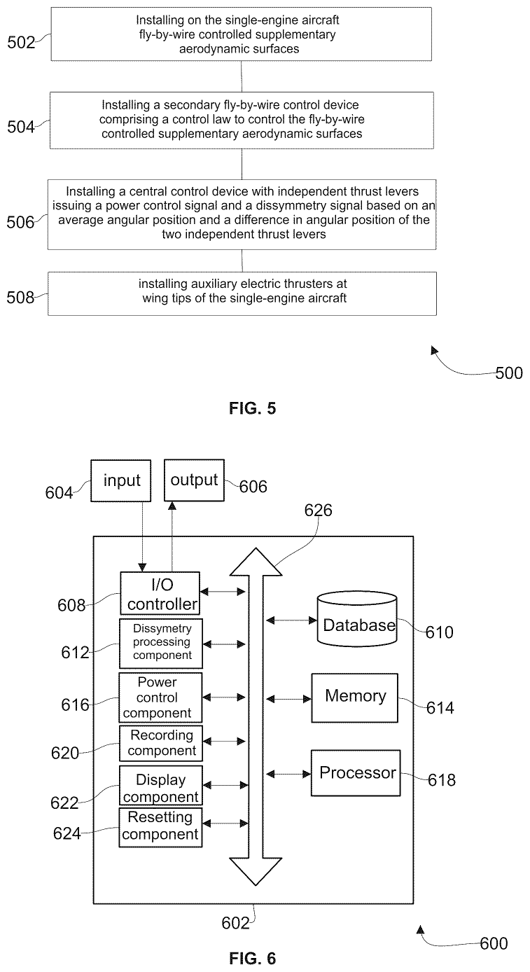

FIG. 5 shows a flowchart 500 illustrating a method for making a single-engine aircraft that may mimic the behavior of a multi-engine aircraft, notably for pilot training purposes, in accordance with various aspects of the present disclosure. The operation of the method may implement techniques, devices and systems as disclosed herein.

At 502 supplementary fly-by-wire controlled aerodynamic surfaces may be installed on a single-engine aircraft. In some implementations the modified single engine aircraft may not be initially equipped with fly-by-wire therefore these additional surfaces may be controlled by an added fly-by-wire control device, or, the single-engine aircraft is already fly-by-wire and the supplementary aerodynamic surfaces may extend existing aerodynamic surfaces to increase their effect.

At 504 a secondary fly-by-wire control device comprising a dedicated control law may be installed for driving the supplementary aerodynamic surfaces and the aircraft engine. When the aircraft is already equipped initially with fly-by-wire, the secondary fly-by-wire control may be interfaced with the existing primary fly-by-wire control device.

At 506 a central thrust control with two independent thrust levers and comprising means for generating a power control signal and a dissymmetry signal according to an average angular position and a difference in angular position of the two thrust levers may be installed in the cockpit. Such a central thrust control may be the same as or similar to the central thrust control 350 disclosed herein.

At 508 the method may optionally comprise installing auxiliary electric thrusters at the wing tips and a battery to supply these thrusters in energy. The operation of the auxiliary thrusters may be driven by the secondary fly-by-wire device.

FIG. 6 shows a diagram 600 of an apparatus 602 supporting techniques for mimicking the behavior of a multi-engine aircraft with a single-engine aircraft in accordance with various aspects of the present disclosure. The apparatus 602 may be the same as or similar to the secondary fly-by-wire control device 434 depicted in FIG. 4. The apparatus may include components for bidirectional communication comprising an I/O controller 608, a database 610, a dissymmetry processing component 612, a memory 614, a power control component 616, a processor 618, a recording component 620, a display component 622, a resetting component 624 and/or other components. These components may be in electronic communication via one or more buses 626.

The I/O controller 608 may manage input signals arriving on an input port 604 and output signals delivered on an output port 606 for the apparatus 602, The I/O controller 608 may also manage peripherals not integrated in the apparatus 602. In some cases, the I/O controller 608 may represent a physical connection or a port to an external peripheral. For instance, the I/O controller 608 may connect the apparatus 602 to an existing primary fly-by-wire control device 402 and/or to one or more added displays 215, 241, 242 in the cockpit.

The input signals arriving on the input port 604 may comprise a power control signal 459, a dissymmetry signal 469, an engine failure simulation signal from the engine failure simulation command 290, a resetting signal from the reset command 291, a left sun-gear angular position sensor 351 signal, a right sun-gear angular position sensor 352 signal, as well as other information taken from the fly-by-wire control device 402 such as broomsticks positions, rudder pedals position and/or from specific sensors of the aircraft such as speed, altitude, landing gear configuration, aerodynamic surfaces positions such as ailerons, rudder, slats, elevators, flaps, information related the main thruster such as rpm and propeller pitch, and when applicable, information related to auxiliary electric thrusters operation and other information.

The database comprises a control law defining a safe flight domain of the mimicked aircraft according to flight parameters and controls.

Memory 614 may include random-access memory (RAM) and read-only memory (ROM). The memory 614 may store computer-readable, computer-executable software including instructions that, when executed, cause the processor to perform various functions described herein. In some cases, the memory 614 may contain, among other things, a basic input/output system (BIOS) which may control basic hardware or software operation such as the interaction with peripheral components or devices.

The memory 614 may also store timestamped flight parameters and controls configuration of the mimicked aircraft in connection with the recording component 620 thus allowing analysis and debriefing after a pilot training session.

The processor 618 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 618 may be configured to operate a memory array using a memory controller. In other cases, a memory controller may be integrated into the processor 618. The processor 618 may be configured to execute computer-readable instructions stored in a memory 614 to perform various functions (e.g., functions or tasks supporting mimicking the behavior of a multi-engine aircraft with a single-engine aircraft).

The dissymmetry processing component 612 may be configured or otherwise support means for interpreting a dissymmetry signal 469 issued by the central thrust control 350 and/or by the engine failure simulation command 290 to generate at least one of a corrected left wing aileron position setpoint signal 435, a corrected right wing aileron position setpoint signal 436, a corrected rudder position setpoint signal 440, and, when applicable, setpoint signals for the auxiliary electric thrusters in connection with the power control component, according to the control law. The dissymmetry processing component 612 in connection with the control law comprised in the database 610 may limit those setpoints in order to keep the aircraft in its safe flight domain.

The power control component 616 may be configured or otherwise support means for interpreting a power control signal 459 issued by the central thrust control 350 and/or by the engine failure simulation command 290 to generate, a corrected propeller speed setpoint signal 432, a corrected propeller pitch setpoint signal 433 and, when applicable, signals for controlling the operation of auxiliary electric thrusters, in connection with the power control component, according to the control law. The dissymmetry processing component 612 in connection with the control law comprised in the database 610 may limit those setpoints in order to keep the aircraft in its safe flight domain.

The display component 622 may be configured or otherwise support means for displaying information on the displays 241, 242, 215 of the cockpit according to the corrected left wing aileron position setpoint signal 435, the corrected right wing aileron position setpoint signal 436, the corrected rudder position setpoint signal 440, the corrected propeller speed setpoint signal 432, the corrected propeller pitch setpoint signal 433, the left sun-gear angular position sensor 351 signal, the right sun-gear angular position sensor 352 signal and, when applicable, signals for controlling the operation of auxiliary electric thrusters, and other flight parameters in order to mimic the displays of a multi-engine aircraft.

The resetting component 624 may be configured or otherwise support means for resetting the aircraft operation mode of the original single-engine aircraft upon receipt of a signal from the reset command. The resetting component 624 in accordance with the control law may bring back a dissymmetric behavior of the aircraft, for instance triggered by the engine failure simulation command 290, to a symmetric behavior, overriding the signals generated by the dissymmetry processing component 612 and the power control component 616 and may also operate in connection with the display component 622 to monitor the displays and return to a single-engine type of display. In flight, the resetting component 624 may monitor the return to a single-engine mode in order to prevent the aircraft exiting from its safe-flight domain. When activated before flight, the resetting component may set the aircraft in a single-engine mode and prevent the dissymmetry processing component 612 and the power control component 616 to alter the set-points of their respective controls. The two thrust levers of the central thrust control 350 may be locked together, and the aircraft may be piloted in its nominal single-engine configuration.

The recording component 620 may be configured or otherwise support means for recording in a memory flight parameters and controls corresponding to the mimicked multi-engine aircraft for analysis and debriefing purpose, Such a memory may be a CDROM, DVDROM, memory card, memory stick or an internal memory accessible through a connection like an USB connection for instance in the cockpit. Such a memory is different than the FDR and the CVR of the aircraft, the latter recording real flight and control parameters and not simulated ones.

The output port 606 may deliver signals after processing by the dissymmetry processing component 612, the power control component 616 and the display component 622 comprising at least one of a corrected left wing aileron position setpoint signal 435, a corrected right wing aileron position setpoint signal 436, a corrected rudder position setpoint signal 440, a corrected propeller speed setpoint signal 432, a corrected propeller pitch setpoint signal 433 and signals for the operation of the auxiliary electric thrusters, when applicable, as well as signals to the displays according to the techniques and methods described herein.

The techniques and methods described herein may be adapted in some implementations to mimic the behavior of a four-engine aircraft with a single engine aircraft. According to some implementation, two central control devices 350 as described herein may be used in parallel. A left part delivering a left dissymmetry signal and a left power control signal according to the angular positions of the two left thrust levers and the same for a right part delivering a right dissymmetry signal and a right power control signal according to the angular positions of the two right thrust levers. These four signals may be conveyed to an adapted dissymmetry processing component and an adapted power control component which may process and issue a corrected left wing aileron position setpoint signal 435, a corrected right wing aileron position setpoint signal 436, a corrected rudder position setpoint signal 440, a corrected propeller speed setpoint signal 432, a corrected propeller pitch setpoint signal 433 and signals for the operation of the auxiliary electric thrusters based on an adapted control law.

It should be noted that the methods described herein describe possible implementations, and that the operations and the steps may be rearranged or otherwise modified and that other implementations are possible. Furthermore, aspects from two or more of the methods may be combined.

Aspect 1: A system for mimicking a behavior of a multi-engine aircraft with a single-engine aircraft comprising: an aircraft comprising an on-board cockpit comprising at least one control device, a main thruster and a fly-by-wire control center configured to move at least one aerodynamic surface among a rudder, a right-wing aileron and a left-wing aileron in response to an action on the at least one control device; the fly-by-wire control center being further configured to modify at least one operating parameter of the main thruster in response to an action on the at least one control device; the at least one control device comprising a central thrust control comprising two independent thrust levers, configured to issue a power control signal and a dissymmetry signal based on an average angular position and a difference in angular position between the two independent thrust levers; the fly-by-wire control center comprising at least one calculator comprising an input port configured to receive a power control signal and a dissymmetry signal, a non-volatile memory comprising a control law and instructions configured to make a processor process the power control signal and the dissymmetry signal an to issue at least one a corrected left wing aileron position setpoint signal, a corrected right wing aileron position setpoint signal, a corrected rudder position setpoint signal, a corrected propeller speed setpoint signal, a corrected propeller pitch setpoint signal; wherein the control law and the processor are configured to mimic the behavior of an aircraft comprising more than one main thruster.

Aspect 2: the system of aspect 1, wherein the main thruster is a turboprop.

Aspect 3: the system of aspects 1 through 2, comprising an auxiliary electric thruster on each wing and the processor and the control law are configured to process at least one operating parameter relating to each auxiliary electric thruster.

Aspect 4: the system of aspects 1 through 3, wherein the at least one control device comprises an engine failure simulation command configured to trigger a mimicked aircraft behavior subject to an engine failure.

Aspect 5: the system of aspects 1 though 4, wherein the at least one control device comprises a reset command configured to exit a mimicked aircraft behavior.

Aspect 6: the system of aspects 1 through 5, wherein the fly-by-wire control center comprises a secondary fly-by-wire control device comprising: a database comprising the control law of a multi-engine mimicked aircraft, a memory comprising instruction to make the processor to process signals arriving on the input port according to: a dissymmetry processing component, a power control component, a display component, a recording component, and a resetting component.

Aspect 7: the system of aspects 1 through 6, wherein the two independent thrust levers of the central thrust control are acting on a power control shaft of the main thruster via a differential gear train comprising a left sun-gear connected to a left-hand thrust lever, a right sun-gear connected to a right-hand thrust lever, a planetary gear geared with the left sun-gear and the right sun-gear and held by a planet carrier, the power control shaft being connected in rotation with the planet carrier.

Aspect 8: the system of aspects 1 through 7, wherein the planetary gear is connected in rotation with a dissymmetry shaft, an angular position of the dissymmetry shaft being set by the difference in angular positions of the two independent thrust levers and measured by a dissymmetry shaft angular sensor issuing the dissymmetry signal.

Aspect 9: the system of aspects 1 through 8, wherein the central thrust control comprises a left sun-gear angular position sensor and a right sun-gear angular position sensor and wherein the display component is configured to generate a signal towards an engine gauge display, showing a thrust power of a left engine and a thrust power of a right engine according to angular positions delivered by the left sun-gear angular position sensor and the right sun-gear angular position sensor.

Aspect 10: The system of aspects 1 to 9, wherein a recording component is configured to record timestamped positions of the left-hand thrust lever and of the right-hand thrust lever from angular positions delivered by the left sun-gear angular position sensor and the right sun-gear angular position sensor.

Aspect 11: a method for adapting a single-engine aircraft for operating like a multi-engine aircraft, implementing a system according to any aspect 1 to 10, comprising steps of: installing on the single-engine aircraft at least one supplementary fly-by-wire controlled aerodynamic surface; installing a secondary fly-by-wire control device comprising a control law and configured to control the at least one supplementary fly-by-wire controlled aerodynamic surface; installing a central thrust control comprising two independent thrust levers configured to issue a power control signal and a dissymmetry signal based on an average angular position and a difference in angular position between the two independent thrust levers; wherein the secondary fly-by-wire control device is configured to issue at least one of a corrected propeller speed setpoint signal, corrected propeller pitch setpoint signal, a corrected aileron position setpoint signal and a corrected rudder position signal from the power control signal and the dissymmetry signal.

Aspect 12: the method of aspect 11, further comprising installing auxiliary electric thrusters at wing tips of the single-engine aircraft wherein operating conditions of the auxiliary electric thrusters are controlled by the secondary fly-by-wire control device based on the power control signal and the dissymmetry signal.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

1. A system for mimicking a behavior of a multi-engine aircraft with a single-engine aircraft comprising:
an aircraft comprising an on-board cockpit comprising at least one control device, a main thruster and a fly-by-wire control center configured to move at least one aerodynamic surface among a rudder, a right-wing aileron and a left-wing aileron in response to an action on the at least one control device;
the fly-by-wire control center being further configured to modify at least one operating parameter of the main thruster in response to an action on the at least one control device;
the at least one control device comprising a central thrust control comprising two independent thrust levers, configured to issue a power control signal and a dissymmetry signal based on an average angular position and a difference in angular position between the two independent thrust levers;
the fly-by-wire control center comprising at least one calculator comprising an input port configured to receive a power control signal and a dissymmetry signal, a non-volatile memory comprising a control law and instructions configured to make the at least one calculator processing the power control signal and the dissymmetry signal and to issue at least one a corrected left wing aileron position setpoint signal, a corrected right wing aileron position setpoint signal, a corrected rudder position setpoint signal, a corrected propeller speed setpoint signal, a corrected propeller pitch setpoint signal;
wherein the control law and the at least one calculator are configured to mimic the behavior of an aircraft comprising more than one thruster.

2. The system of claim 1, wherein the main thruster is a turboprop.

3. The system of claim 1, comprising an auxiliary electric thruster on each wing wherein the at least one calculator and the control law are configured to process at least one operating parameter relating to each auxiliary electric thruster.

4. The system of claim 1, wherein the at least one control device comprises an engine failure simulation command configured to trigger a mimicked aircraft behavior subject to an engine failure.

5. The system of claim 4, wherein the at least one control device comprises a reset command configured to exit the mimicked aircraft behavior.

6. The system of claim 1, wherein the fly-by-wire control center comprises a secondary fly-by-wire device comprising:
a database comprising the control law of a multi-engine mimicked aircraft,
a processor,
a memory comprising instructions to make the processor to process signals arriving on the input port according to:
a dissymmetry processing component,
a power control component,
a display component,
a recording component, and
a resetting component.

7. The system of claim 6, wherein the two independent thrust levers of the central thrust control are acting on a power control shaft of the main thruster via a differential gear train comprising a left sun-gear connected to a left-hand thrust lever, a right sun-gear connected to a right-hand thrust lever, a planetary gear geared with the left sun-gear and the right sun-gear and held by a planet carrier, the power control shaft being connected in rotation with the planet carrier.

8. The system of claim 7, wherein the planetary gear is connected in rotation with a dissymmetry shaft, an angular position of the dissymmetry shaft being set by the difference in angular positions of the two independent thrust levers and measured by a dissymmetry shaft angular sensor issuing the dissymmetry signal.

9. The system of claim 7, wherein the central thrust control comprises a left sun-gear angular position sensor and a right sun-gear angular position sensor and wherein the display component is configured to generate a signal towards an engine gauges display, showing a thrust power of a left engine and a thrust power of a right engine according to angular positions delivered by the left sun-gear angular position sensor and the right sun-gear angular position sensor.

10. The system of claim 9, wherein the recording component is configured to record timestamped positions of the left-hand thrust lever and of the right-hand thrust lever from angular positions delivered by the left sun-gear angular position sensor and the right sun-gear angular position sensor.

11. A method for adapting a single-engine aircraft for operating like a multi-engine aircraft, comprising steps of:
installing on the single-engine aircraft at least one supplementary fly-by-wire controlled aerodynamic surface;
installing a secondary fly-by-wire control device comprising a control law and configured to control the at least one supplementary fly-by-wire controlled aerodynamic surface;
installing a central thrust control comprising two independent thrust levers configured to issue a power control signal and a dissymmetry signal based on an average angular position and a difference in angular position between the two independent thrust levers;
wherein the secondary fly-by-wire control device is configured to issue at least one of a corrected propeller speed setpoint signal, a corrected propeller pitch setpoint signal, corrected ailerons positions setpoint signals and a corrected rudder position signal from the power control signal and the dissymmetry signal.

12. The method of claim 11, further comprising installing auxiliary electric thrusters at wing tips of the single-engine aircraft wherein operating conditions of the auxiliary electric thrusters are controlled by the secondary fly-by-wire control device based on the power control signal and the dissymmetry signal.
